(19) United States
(12) Patent Application Publication
(10) Pub. No.: US 2004/0054033 A1
(43) Pub. Date: Mar. 18, 2004

(54) Surface-treated carbon black and rubber composition containing the same

(76) Inventor: Yoshiaki Kirino, Kanagawa (JP)

Correspondence Address: Rader Fishman & Grauer, Suite 501, 1233 20th Street NW, Washington, DC, 20036, US

(21) Appl. No.: 10/250,657

(22) PCT Filed: Nov. 14, 2002
(86) PCT No.: PCT/JP02/11887

(30) Foreign Application Priority Data
Nov. 20, 2001 (JP) 2001-354954

(51) Int. Cl. C09C 1/48; C08K 3/04; C08K 9/00

(52) U.S. Cl. 523/215; 423/449.2; 524/495

(57) ABSTRACT

A surface-treated carbon black obtained by coating the surface of carbon black with a mixture of (A) a silane compound having an amino group and (B) a silicon-containing compound having substantially all organic groups bonded with silicon through oxygen, whereby a resistance to heat buildup and abrasion resistance are improved and dispersability into a rubber compound is improved.

### TECHNICAL FIELD

The present invention relates to a modified surface-treated carbon black, more particularly relates to a carbon black treated, on the surface thereof, with two specific types of organic silicon compounds and a rubber composition containing the same.

### BACKGROUND ART

In the past, carbon black treated, on the surface thereof, with an organic silicon compound is disclosed, for example, in Japanese Unexamined Patent Publication (Kokai) No. 10-046047 or Japanese Unexamined Patent Publication (Kokai) No. 11-116841, as a rubber reinforcing filler for giving a low heat buildup and improving the abrasion resistance. Further, carbon black treated, on the surface thereof, with aminosilane is described in Japanese Unexamined Patent Publication (Kokai) No. 9-087612. Further, a silicon-treated carbon black pretreated with a coupling agent is described in Japanese Unexamined Patent Publication (PCT Kokai) No. 2001-500919.

### DISCLOSURE OF THE INVENTION

The object of the present invention is to provide a surface-treated carbon black having the improved resistance to heat buildup and abrasion resistance and having the improved dispersibility at the time of blending with rubber.

In accordance with the present invention, there is provided a surface-treated carbon black comprising a carbon black coated on the surface thereof with a mixture of (A) a silane compound having an amino group and (B) a silicon-containing compound having substantially all organic groups bonded with silicon through oxygen.

In accordance with the present invention, there is also provided a rubber composition comprising 5 to 100 parts by weight of the above surface-treated carbon black compounded into 100 parts by weight of a diene-based rubber.

In accordance with the present invention, there is further provided a rubber composition comprising 1 to 20% by weight of a silane coupling agent based upon the weight of the surface treated carbon black, in addition to the above surface treated carbon black.

### BEST MODE FOR CARRYING OUT THE INVENTION

In the present invention, it was found that, by coating a carbon black, in a suspension, with a predetermined amount of a mixture of (A) a silane compound having an amino group and (B) a silicon-containing compound having substantially all organic groups bonded with silicon through oxygen, it is possible to prevent coagulation of the surface treated carbon black so obtained and that, further, when blending the surface-treated carbon black into a rubber, as a rubber reinforcing filler, the resistance to heat buildup and abrasion resistance of the rubber composition are improved and the dispersibility (or processability) of the surface-treated carbon black in the rubber is improved.

The silane compound (A) having the amino group used in the present invention is expressed by the formula (I):

(R¹O)ₚ(R²)₃₋ₚ—Si—R³ (I)

wherein R¹ independently indicates a C₁ to C₄ alkyl group, R² independently indicates a C₁ to C₃ alkyl group, R³ indicates an alkyl group having one or more carbon atoms and having at least one primary to tertiary amino group and p is an integer of 3 or less. Examples thereof are, N-β-aminoethyl-γ-aminopropyldimethylmethoxysilane, N-β-aminoethyl-γ-aminopropylmethyldimethoxysilane, N-β-aminoethyl-γ-aminopropyltrimethoxysilane, N-β-aminoethyl-γ-aminopropyltriethoxysilane, γ-aminopropyltrimethoxysilane, γ-aminopropyltriethoxy silane, N-phenyl-γ-aminopropyltrimethoxysilane, etc.

The above-mentioned silicon-containing compound (B) having substantially all organic groups bonded with silicon through oxygen is expressed by the formula (II):

(RO)₃—Si—O—[Si(OR)ₙ—O₃₋ₙ]ₘR (II)

wherein R independently indicates hydrogen or a C₁ to C₄ alkyl group, n is 1 or 2 and m is an integer of 0 or more. Specifically, tetramethoxysilane, tetraethoxysilane, and lower condensates thereof, that is, oligomers thereof may be mentioned. Examples of the oligomers are commercially available products such as MKC Silicate MS51 (made by Mitsubishi Chemical), Silicate 40 (made by Tama Chemical Industry).

The amount of treating of the compound (A) in the surface-treated carbon black of the present invention is preferably 0.1 to 20% by weight, more preferably 0.2 to 10% by weight, based upon the weight of the carbon black. Further, the amount of treating of the compound (B) is preferably 0.1 to 20% by weight, more preferably 0.2 to 10% by weight, based upon the weight of the carbon black. If the amounts of treating are too high, the amount of poor dispersion of the filler in the rubber is liable to become greater. Further, the physical properties such as breakage characteristics, abrasion resistance are conversely liable to deteriorate. On the other hand, if the amounts of treating are too small, the desired effect is liable not to be sufficiently obtained.

As the process for producing the surface-treated carbon black of the present invention, it is possible to adopt, for example, the following method. First, an aqueous solution of 20% by weight of the compound (A) and a suspension or emulsion of 20% by weight of the compound (B) were prepared. These are first mixed together to obtain an aqueous suspension or emulsion of a mixture of the compounds (A) and (B), which is then added to a conainer provided with a stirrer containing a predetermined amount of carbon black followed by, sufficiently stirring, then the surface treated carbon black thus obtained is separated and taken out, followed by drying. Note that the aqueous solution of the compound (A) and the suspension (or emulsion) of the compound (B) can also be simultaneously added for the surface treatment.

The carbon black used for the surface-treated carbon black of the present invention is not particularly limited, but, for example, a carbon black having an N₂SA (i.e., a nitrogen specific surface area) of at least 70 m²/g and a DBP oil absorption of at least 90 ml/100 g is preferable. Further, a carbon black having an N₂SA of 80 to 200 m²/g and a DBP oil absorption of 100 to 150 ml/100 g is more preferable. If the values of these physical properties are too low, the tensile strength, modulus, etc. are liable to become lower, while conversely if too high, the heat buildup is liable to become greater in the case of N₂SA. Carbon black having an extremely high DBP oil absorption is sometimes difficult to produce.

The rubber component used in the rubber composition of the present invention is a diene-based rubber generally used for a tire from the past. Specifically, natural rubber (NR), polyisoprene rubber (IR), various types of styrene-butadiene copolymer rubber (SBR), various types of polybutadiene rubber (BR), acrylonitrile-butadiene copolymer rubber (NBR), butyl rubber (IIR), etc. may be mentioned. These may be used alone or in mixtures of two or more types of rubbers. A mixture of natural rubber and another diene-based synthetic rubber or rubbers is preferably made a rubber mixture containing at least 60% by weight of natural rubber in relation to the desired object.

In the rubber composition of the present invention, it is preferable to use 5 to 100 parts by weight of the above surface-treated carbon black, based upon 100 parts by weight of a diene-based rubber. If a formulation of less than 5 parts by weight, the desired action and effect cannot be exhibited. Further, if a formulation of more than 100 parts by weight, it becomes difficult to maintain a good dispersion of the surface-treated carbon black in the rubber.

Further, preferably the rubber composition of the present invention further contains 1 to 20% by weight of a silane coupling agent, based upon the weight of the surface treated carbon black. If the formation amount of the silane coupling agent is less than 1% by weight, the desired effect cannot be obtained, while if the amount is more than 20% by weight, scorch is unpreferably easy to occur at the mixing or extrusion step.

The rubber composition of the present invention may further contain therein, in addition to the above-mentioned components, various compounding agents usually formulates for tire or other general rubber use, such as a vulcanization or cross-linking agent, a vulcanization or cross-linking accelerator, various types of oils, antioxidants, plasticizers. These compounding agents can be mixed and vulcanized to form rubber compositions by general methods and used for vulcanization or cross-linking. The formation amounts of these additives may be made amounts generally used in the past, unless the object of the present invention is not adversely affected.

### EXAMPLES

The present invention will now be explained in further detail using Examples and Comparative Examples, but the technical scope of the present invention is of course not limited to these Examples.

### Examples 1 to 17 and Comparative Examples 1 to 6

### Preparation of Surface-Treated Carbon Black (CB)

1) Surface-Treated CB-1 to CB-7 and CB-14 and CB-15

First, MKC Silicate MS51 made by Mitsubishi Chemical and a surfactant (i.e., nonionic emulsifier) were mixed using an equal amount of water as the carbon black to form an emulsion. Next, the various aminosilanes shown in the following Tables were added, then the resultant mixtures were stirred, then finally the carbon blacks shown in the following Tables were added and mixed therewith and then dried to thereby obtain the predetermined surface-treated carbon blacks.

2) CB-8

ISAF grade carbon black was treated only with water.

3) Surface Treated CB-9

First, Silicate MS51 made by Mitsubishi Chemical and a surfactant (i.e., nonionic emulsifier) were mixed with an equal amount of water as the carbon black to form an emulsion, then carbon black was added and mixed with the emulsion and then dried to thereby obtain a predetermined surface-treated carbon black.

4) Surface Treated CB-10 to CB-13

The above surface-treated CB-9 was added and mixed with solutions obtained by dissolving the surface treated CB-9 in 10 times amount of methanol, the various aminosilanes shown in the Table, then the resultant mixture was dried to thereby obtain a predetermined surface-treated carbon black.

### Preparation of Test Samples

Using the surface-treated carbon blacks having the compositions (parts by weight) shown in the following Table I, the ingredients other than the sulfur and vulcanization accelerator in the rubber ingredients of the examples shown in the following Table II were mixed in a 1.8 liter internal mixer for 3 to 5 minutes and discharged when reaching 165±5° C. to obtain master batches. The sulfur and vulcanization accelerators were added to these master batches and mixed by an 8-inch open roll to obtain the rubber compositions. Next, these rubber compositions were press vulcanized in a 15 cm×15 cm×0.2 cm mold at 160° C. for 20 minutes to fabricate the intended test pieces (i.e., rubber sheets) and were measured and evaluated by the test methods shown below as to the tensile strength, dispersibility, viscoelasticity and abrasion resistance.

TABLE I

| | Surface- | Surface- | Surface- | Surface- | Surface- | Surface- | Surface- |
|---|---|---|---|---|---|---|---|
| | treated | treated | treated | treated | treated | treated | treated |
| | CB-1 | CB-2 | CB-3 | CB-4 | CB-5 | CB-6 | CB-7 |
| ISAF grade carbon black*1 | 100 | 100 | 100 | 100 | 100 | 100 | 100 |
| Oligomer of tetramethoxysilane | 0.1 | 2 | 5 | 20 | 5 | 5 | 5 |
| condensate*2 | | | | | | | |
| N-β(aminoethyl)-γ-aminopropyl- | 0.1 | 2 | 2 | 20 | — | — | — |
| trimethoxysilane*3 | | | | | | | |
| N-β(aminoethyl)-γ-aminopropyl- | — | — | — | — | 2 | — | — |
| methyldimethoxysilane*4 | | | | | | | |
| N-β(aminoethyl)-γ-aminopropyl- | — | — | — | — | — | 2 | — |
| triethoxysilane*5 | | | | | | | |
| γ-aminopropyltrimethoxysilane*6 | — | — | — | — | — | — | 2 |

| | Surface- | Surface- | Surface- | Surface- | Surface- | Surface- | Surface- | Surface- |
|---|---|---|---|---|---|---|---|---|
| | treated | treated | treated | treated | treated | treated | treated | treated |
| | CB-8 | CB-9 | CB-10 | CB-11 | CB-12 | CB-13 | CB-14 | CB-15 |
| ISAF grade carbon black*1 | 100 | 100 | 100 | 100 | 100 | 100 | 100 | 100 |
| Oligomer of tetramethoxysilane | — | 5 | 5 | 5 | 5 | 5 | 0.05 | 25 |
| condensate*2 | | | | | | | | |
| N-β(aminoethyl)-γ-aminopropyl- | — | — | 2 | — | — | — | 0.05 | 25 |
| trimethoxysilane*3 | | | | | | | | |
| N-β(aminoethyl)-γ-aminopropyl- | — | — | — | 2 | — | — | — | — |
| methyldimethoxysilane*4 | | | | | | | | |
| N-β(aminoethyl)-γ-aminopropyl- | — | — | — | — | 2 | — | — | — |
| triethoxysilane*5 | | | | | | | | |
| γ-aminopropyltrimethoxysilane*6 | — | — | — | — | — | 2 | — | — |

Table I Notes
*1: Carbon black #40 made by Mitsubishi Chemical (N₂SA: 115 m²/g, DPB oil absorption 110 ml/100 g)
*2: MKC Silicate MS51 made by Mitsubishi Chemical
*3: Aminosilane made by Shin-Etsu Chemical
*4: Aminosilane made by Shin-Etsu Chemical
*5: Aminosilane made by Shin-Etsu Chemical
*6: Aminosilane made by Shin-Etsu Chemical

### Test Method

1) Tensile strength: 100% modulus (MPa), strength at break (MPa), elongation at break (%) measured according to JIS K6251.

2) Dispersibility: Presence of 2 or less poorly dispersed clumps of 100 μm or more in a 5 mm square rubber cutting section . . . ◯, presence of 3 to 10 . . . Δ, and presence of 11 or more . . . X.

3) Viscoelasticity: tan δ (60° C.) measured using a viscoelasticity spectrometer made by Toyo Seiki under conditions of initial strain: 10%, amplitude: ±2%, and frequency: 20 Hz. The lower the value of the tan δ (60° C.), the lower the heat buildup.

4) Abrasion resistance: Measured using a Lambourn abrasion tester (made by Iwamoto Seisakusho) under conditions of a load of 5 kg, a slip rate of 25%, a time of 4 minutes and room temperature. The amount of abrasion loss indicated indexed to Comparative Example 1 as 100. The larger the value, the better the abrasion resistance.

The results are shown in the following Table II.

TABLE II

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Formulation | | | | | | | | | |
| (parts by weight) | | | | | | | | | |
| Oil extended SBR*1 | 137.5 | 137.5 | 137.5 | 137.5 | 137.5 | 137.5 | 137.5 | 137.5 | 137.5 |
| Surface treated CB-1 | 80 | — | — | — | — | — | — | — | — |
| Surface treated CB-2 | — | 80 | — | — | — | — | — | — | — |
| Surface treated CB-3 | — | — | 80 | — | — | — | — | — | — |
| Surface treated CB-4 | — | — | — | 80 | — | — | — | — | — |
| Surface treated CB-5 | — | — | — | — | 80 | — | — | — | — |
| Surface treated CB-6 | — | — | — | — | — | 80 | — | — | — |
| Surface treated CB-7 | — | — | — | — | — | — | 80 | — | — |
| Surface treated CB-8 | — | — | — | — | — | — | — | — | — |
| Surface treated CB-9 | — | — | — | — | — | — | — | — | — |
| Surface treated CB-10 | — | — | — | — | — | — | — | — | — |
| Surface treated CB-11 | — | — | — | — | — | — | — | — | — |
| Surface treated CB-12 | — | — | — | — | — | — | — | — | — |
| Surface treated CB-13 | — | — | — | — | — | — | — | — | — |
| Surface treated CB-14 | — | — | — | — | — | — | — | 80 | — |
| Surface treated CB-15 | — | — | — | — | — | — | — | — | 80 |
| Silane coupling agent*2 | 4 | 4 | 4 | 4 | 4 | 4 | 4 | 4 | 4 |
| Zinc white | 3 | 3 | 3 | 3 | 3 | 3 | 3 | 3 | 3 |
| Stearic acid | 2 | 2 | 2 | 2 | 2 | 2 | 2 | 2 | 2 |
| Aromatic oil | 12.5 | 12.5 | 12.5 | 12.5 | 12.5 | 12.5 | 12.5 | 12.5 | 12.5 |
| Sulfur | 2 | 2 | 2 | 2 | 2 | 2 | 2 | 2 | 2 |
| Vulcanization accelerator | 1.75 | 1.75 | 1.75 | 1.75 | 1.75 | 1.75 | 1.75 | 1.75 | 1.75 |
| CZ*3 | | | | | | | | | |
| Vulcanization accelerator | 0.5 | 0.5 | 0.5 | 0.5 | 0.5 | 0.5 | 0.5 | 0.5 | 0.5 |
| DPG*4 | | | | | | | | | |
| (Total weight) | (243.25) | (243.25) | (243.25) | (243.25) | (243.25) | (243.25) | (243.25) | (243.25) | (243.25) |
| Evaluated | | | | | | | | | |
| physical properties | | | | | | | | | |
| Tensile strength | | | | | | | | | |
| M100 (MPa) | 2.4 | 2.6 | 2.6 | 3.0 | 2.6 | 2.6 | 2.5 | 2.3 | 3.2 |
| T_{B} (MPa) | 24.1 | 24.0 | 24.5 | 25.5 | 24.6 | 24.4 | 24.2 | 24.0 | 25.0 |
| E_{B} (%) | 483 | 465 | 470 | 435 | 468 | 471 | 465 | 482 | 425 |
| Dispersibility | ◯ | ◯ | ◯ | ◯ | ◯ | ◯ | ◯ | Δ | Δ |
| tanδ (60° C.) | 0.287 | 0.258 | 0.260 | 0.212 | 0.260 | 0.260 | 0.265 | 0.289 | 0.213 |
| Abrasion resistance | 102 | 115 | 120 | 102 | 120 | 120 | 116 | 100 | 100 |
| (index) | | | | | | | | | |

(Notes)
*1: Oil extended SBR Nipol 1712 made by Nippon Zeon (SBR: 100 parts, aromatic oil 37.5 parts)
*2: Si69 (bis(3-triethoxysilylpropyl)tetrasulfide) (made by Degussa)
*3: N-cyclohexyl-2-benzothiazolylsulfenamide (made by Ouchi Shinko Chemical)
*4: 1,3-diphenylguanidine (made by Flexis)

| | Ex. 10 | Ex. 11 | Ex. 12 | Ex. 13 | Ex. 14 | Ex. 15 | Ex. 16 | Ex. 17 |
|---|---|---|---|---|---|---|---|---|
| Formulation (parts by weight) | | | | | | | | |
| Oil extended SBR*1 | 137.5 | 137.5 | 137.5 | 137.5 | 137.5 | 137.5 | 137.5 | 137.5 |
| Surface treated CB-1 | — | — | — | — | — | — | — | — |
| Surface treated CB-2 | — | — | — | — | — | — | — | — |
| Surface treated CB-3 | 3 | 5 | 100 | 110 | 80 | 80 | 80 | 80 |
| Surface treated CB-4 | — | — | — | — | — | — | — | — |
| Surface treated CB-5 | — | — | — | — | — | — | — | — |
| Surface treated CB-6 | — | — | — | — | — | — | — | — |
| Surface treated CB-7 | — | — | — | — | — | — | — | — |
| Surface treated CB-8 | 77 | 75 | 20 | 10 | — | — | — | — |
| Surface treated CB-9 | — | — | — | — | — | — | — | — |
| Surface treated CB-10 | — | — | — | — | — | — | — | — |
| Surface treated CB-11 | — | — | — | — | — | — | — | — |
| Surface treated CB-12 | — | — | — | — | — | — | — | — |
| Surface treated CB-13 | — | — | — | — | — | — | — | — |
| Surface treated CB-14 | — | — | — | — | — | — | — | — |
| Surface treated CB-15 | — | — | — | — | — | — | — | — |
| Silane coupling agent*2 | 4 | 4 | 4 | 4 | 0.5 | 1 | 20 | 25 |
| Zinc white | 3 | 3 | 3 | 3 | 3 | 3 | 3 | 3 |
| Stearic acid | 2 | 2 | 2 | 2 | 2 | 2 | 2 | 2 |
| Aromatic oil | 12.5 | 12.5 | 12.5 | 12.5 | 12.5 | 12.5 | 12.5 | 12.5 |
| Sulfur | 2 | 2 | 2 | 2 | 2 | 2 | 2 | 2 |
| Vulcanization accelerator CZ*3 | 1.75 | 1.75 | 1.75 | 1.75 | 1.75 | 1.75 | 1.75 | 1.75 |
| Vulcanization accelerator DPG*4 | 0.5 | 0.5 | 0.5 | 0.5 | 0.5 | 0.5 | 0.5 | 0.5 |
| (Total weight) | (243.25) | (243.25) | (303.25) | (303.25) | (239.75) | (240.25) | (259.25) | (264.25) |
| Evaluated physical properties | | | | | | | | |
| Tensile strength | | | | | | | | |
| M100 (MPa) | 2.4 | 2.5 | 2.0 | 2.1 | 2.4 | 2.4 | 2.8 | 2.8 |
| T_{B} (MPa) | 23.8 | 24.1 | 26.3 | 25.9 | 23.9 | 24.3 | 24.3 | 24.1 |
| E_{B} (%) | 482 | 475 | 660 | 590 | 481 | 478 | 430 | 429 |
| Dispersability | ◯ | ◯ | ◯ | Δ | ◯ | ◯ | ◯ | ◯ |
| tanδ (60° C.) | 0.272 | 0.270 | 0.390 | 0.390 | 0.289 | 0.273 | 0.241 | 0.241 |
| Abrasion resistance (index) | 102 | 105 | 110 | 103 | 102 | 107 | 105 | 102 |

*1 to *4: See notes in Table II.

| | Comp. | Comp. | Comp. | Comp. | Comp. | Comp. |
|---|---|---|---|---|---|---|
| | Ex. 1 | Ex. 2 | Ex. 3 | Ex. 4 | Ex. 5 | Ex. 6 |
| Formulation (parts by weight) | | | | | | |
| Oil extended SBR*1 | 137.5 | 137.5 | 137.5 | 137.5 | 137.5 | 137.5 |
| Surface treated CB-1 | — | — | — | — | — | — |
| Surface treated CB-2 | — | — | — | — | — | — |
| Surface treated CB-3 | — | — | — | — | — | — |
| Surface treated CB-4 | — | — | — | — | — | — |
| Surface treated CB-5 | — | — | — | — | — | — |
| Surface treated CB-6 | — | — | — | — | — | — |
| Surface treated CB-7 | — | — | — | — | — | — |
| Surface treated CB-8 | 80 | — | — | — | — | — |
| Surface treated CB-9 | — | 80 | — | — | — | — |
| Surface treated CB-10 | — | — | 80 | — | — | — |
| Surface treated CB-11 | — | — | — | 80 | — | — |
| Surface treated CB-12 | — | — | — | — | 80 | — |
| Surface treated CB-13 | — | — | — | — | — | 80 |
| Surface treated CB-14 | — | — | — | — | — | — |
| Surface treated CB-15 | — | — | — | — | — | — |
| Silane coupling agent*2 | 4 | 4 | 4 | 4 | 4 | 4 |
| Zinc white | 3 | 3 | 3 | 3 | 3 | 3 |
| Stearic acid | 2 | 2 | 2 | 2 | 2 | 2 |
| Aromatic oil | 12.5 | 12.5 | 12.5 | 12.5 | 12.5 | 12.5 |
| Sulfur | 2 | 2 | 2 | 2 | 2 | 2 |
| Vulcanization accelerator CZ*3 | 1.75 | 1.75 | 1.75 | 1.75 | 1.75 | 1.75 |
| Vulcanization accelerator DPG*4 | 0.5 | 0.5 | 0.5 | 0.5 | 0.5 | 0.5 |
| (Total weight) | (243.25) | (243.25) | (243.25) | (243.25) | (243.25) | (243.25) |
| Evaluated physical properties | | | | | | |
| Tensile strength | | | | | | |
| M100 (MPa) | 2.4 | 2.4 | 2.5 | 2.5 | 2.5 | 2.4 |
| T_{B} (MPa) | 23.7 | 23.5 | 24.1 | 23.9 | 24.1 | 23.7 |
| E_{B} (%) | 482 | 479 | 430 | 431 | 430 | 428 |
| Dispersability | ◯ | Δ | X | X | X | X |
| tanδ (60° C.) | 0.291 | 0.280 | 0.272 | 0.272 | 0.272 | 0.273 |
| Abrasion resistance (index) | 100 | 98 | 101 | 101 | 102 | 101 |

*1 to *4. See notes in Table II.

### INDUSTRIAL APPLICABILITY

As explained above, it is clear that a rubber composition using the surface-treated carbon black of the present invention is superior in the resistance to heat buildup and abrasion resistance. Further, as an observation of the dispersibility and processability at the time of mixing with rubber, the results were all good. Therefore, a rubber composition containing the surface-treated carbon black of the present invention is suitable for use for a tire compound.

1. A surface-treated carbon black comprising a carbon black coated on the surface thereof with a mixture of (A) a silane compound having an amino group and (B) a silicon-containing compound having substantially all organic groups bonded with silicon through oxygen.

2. A surface-treated carbon black as claimed in claim 1 wherein the carbon black is coated with a mixture of 0.1 to 20% by weight of the silane compound (A) and 0.1 to 20% by weight of the silicon-containing compound (B), based upon the total weight of the carbon black.

3. A rubber composition comprising 100 parts by weight of a diene-based rubber and 5 to 100 parts by weight of the surface-treated carbon black according to claim 1.

4. A rubber composition as claimed in claim 3, wherein said surface-treated carbon black is coated with a mixture of 0.1 to 20% by weight of the silane compound (A) and 0.1 to 20% by weight of the silicon-containing compound (B), based upon the total weight of the carbon black.

5. A rubber composition as claimed in claim 3 further comprising 1 to 20% by weight of a silane coupling agent, based upon the weight of the surface-treated carbon black.

6. A process for producing a surface-treated carbon black according to claim 1 characterized by comprising mixing, with water, the silicon-containing compound (B) having substantially all organic groups bonded with silicon through oxygen, then adding the silane compound (A) having an amino group to the suspension thus obtained, followed by stirring and finally adding the carbon black thereto, followed by mixing and drying.

7. A production process as claimed in claim 6, wherein said suspension is an emulsion obtained by emulsifying the silicon-containing compound with a surfactant.
